(19) United States
(12) Patent Application Publication
(10) Pub. No.: US 2005/0252976 A1
(43) Pub. Date: Nov. 17, 2005

(54) Identification badge and method of manufacturing the same

(76) Inventor: Vaughn R. Dietze, Chicago, IL (US)

Correspondence Address: JENKENS & GILCHRIST, P.C., 225 WEST WASHINGTON, SUITE 2600, CHICAGO, IL, 60606, US

(21) Appl. No.: 10/847,193

(22) Filed: May 17, 2004

(51) Int. Cl. G06K 19/02; G06K 19/06

(52) U.S. Cl. 235/488; 235/492

(57) ABSTRACT

An identification badge comprises a first layer, a second layer, an RFID device, and a third layer. The identification badge is adapted to be used in conjunction with a lead retrieval device at a convention, trade show, exhibition, or the like, in order to generate customer leads for exhibitors at such an event. The RFID device stores information about a visitor to the event, such as the visitor's name and phone number, and is able to communicate this stored information to the lead retrieval device. A method for manufacturing an identification badge provides a first layer, a third layer, and an RFID device. A second layer being an adhesive is applied to the first layer, and the RFID device and the third layer are secured by the second layer.

### FIELD OF THE INVENTION

This invention is directed generally to an identification badge to be worn by a person at an exhibition, tradeshow, convention, conference, or the like. More particularly, the present invention relates to identification badge that contains an Radio Frequency Identification (RFID) device that is capable of storing and transmitting information to an RFID reader and a method for manufacturing such an identification badge.

### BACKGROUND OF THE INVENTION

Exhibitions, tradeshows, conventions, and the like, play an important role in bringing together suppliers of goods and services and their potential customers in an environment that allows a great deal of interaction. A supplier of goods or services (also referred to as an “exhibitor”) will often have a display, booth, or exhibit at an exhibition, and existing or potential customers (also referred to as “visitors”) may visit this booth in order to obtain additional information about the supplier or exhibitor. As such a potential customer may interact with a great number of exhibitors in a short amount of time and at one location during the exhibition. This allows the visitor to see the various goods and services that exhibitors are offering and start new business relationships or expand existing business relationships. The exhibitors benefit by being able to interact with a great number of potential customers without having to initiate contact with these potential customers. However, one problem that arises at exhibitions is the need for the exhibitors to be able to quickly and accurately obtain information from the visitors such as the visitor's contact information and whether the visitor wishes to receive additional information from the exhibitor. The acquisition of this information from the visitor by the exhibitor is often referred to as “lead retrieval.”

Many attempts have been made to help improve the lead retrieval of exhibitors at exhibitions. Some of the first lead retrieval methods involved conventional paper methods such as exchanging business cards or filling out forms at the exhibitor's booth. However, these methods have several drawbacks such as the amount of time and effort it takes to process information from a business card or form, the risk that the card or form would be lost or misplaced, and the risk that the form may not be properly filled out. In the recent past most exhibitions have begun issuing badges or tags to visitors that contain certain information. Almost all of these badges include the name of the visitor and many also include the company or organization that the visitor represents. More recently these visitor badges have included bar codes, magnetic strips, RFID devices, or combinations thereof, to assist the exhibitor's lead retrieval efforts. Visitor badges with bar codes have been particularly popular due to the low cost of the badge, as the bar code may simply be printed on the badge when the visitor's name is printed on the badge. Bar code readers are also widely available and most people are widely familiar with bar codes and bar code readers from their widespread use in retail environments, such as department stores and grocery stores.

Visitor badges containing bar codes, magnetic strips, and combinations thereof, are able to contain contact information about a visitor in a format that can be read by a bar code reader or magnetic card reader at an exhibitor's booth. The information read from the visitor's badge can then be stored in an electronic media, such as a computer hard drive, a computer disk, or any other form of electronic memory, for easy retrieval by the exhibitor at a later time. However, to read a bar code or a magnetic strip, a direct line of sight to the bar code and or magnetic strip is required. This often requires a visitor to remove the visitor badge so that it may be read, particularly with a magnetic strip type badge. This requires the visitor to handle the visitor badge quite often, which can prove frustrating or even damage the visitor badge.

Visitor badges that contain an RFID device have the advantage of being able to be read remotely. This is an advantage as the visitor does not have to handle the visitor badge as frequently and the risk of damaging or losing the visitor badge is thus greatly reduced. Additionally, RFID badges may be read more quickly than a bar code badge or a magnetic strip badge. However, current RFID badges are costly to make, particularly when compared to a bar code badge. Additionally, bar code badges may be produced by the exhibition organizer. This saves the exhibition organizer money, as the organizer does not have to hire an outside firm to generate the visitor badges for the exhibition. Therefore, a need exists for a low cost RFID badge that the exhibition organizer may generate.

### SUMMARY OF THE INVENTION

According to one embodiment, a trade show identification badge comprises a first layer, a second layer being an adhesive, an RFID device, and a third layer. The RFID device is secured between the first layer and the third layer by the second layer. The second layer secures the first layer to the third layer.

According to another embodiment of the present invention, a trade show identification badge comprises a first layer, an RFID device, a second layer, and at least one fastener. The first layer has an inner surface and an outer surface. The RFID device includes a memory and an antenna. The RFID device contacts the inner surface of the first layer. The second layer has an inner surface and an outer surface. The inner surface of the second layer contacts the RFID device and the inner surface of the first layer. The at least one fastener secures the second layer to the first layer. The at least one fastener secures the RFID device between the first layer and the second layer.

According to one method of the present invention, a trade show identification badge is manufactured. The method provides a first layer having an inner and an outer surface, an RFID device, and a third layer having an inner and an outer surface. A second layer is applied to the inner surface of the first layer. The RFID device is secured by the second layer. The inner surface of the third layer is secured by the second layer.

According to another method of the present invention, a trade show identification badge is manufactured. The method provides a first layer having an inner surface and an outer surface, an RFID device, a second layer having an inner surface and an outer surface, and at least one fastener. The method places the RFID device in contact with the inner surface of the first layer. The method secures the second layer to the first layer with the at least one fastener, such that the RFID device is secured between the inner surface of the first layer and the inner surface of the second layer.

### BRIEF DESCRIPTION OF THE DRAWINGS

In the drawings:

FIG. 1 is a perspective view according to one embodiment of the present invention;

FIG. 2 is a partial perspective view according to one embodiment of the present invention; and

FIG. 3 is a cross-section view according to one embodiment of the present invention.

While the invention is susceptible to various modifications and alternative forms, specific embodiments thereof have been shown by way of example in the drawings and will herein be described in detail. It should be understood, however, that it is not intended to limit the invention to the particular forms disclosed, but, on the contrary, the intention is to cover all modifications, equivalents, and alternatives falling within the spirit and scope of the invention as defined by the appended claims.

### DETAILED DESCRIPTION OF THE ILLUSTRATED EMBODIMENT

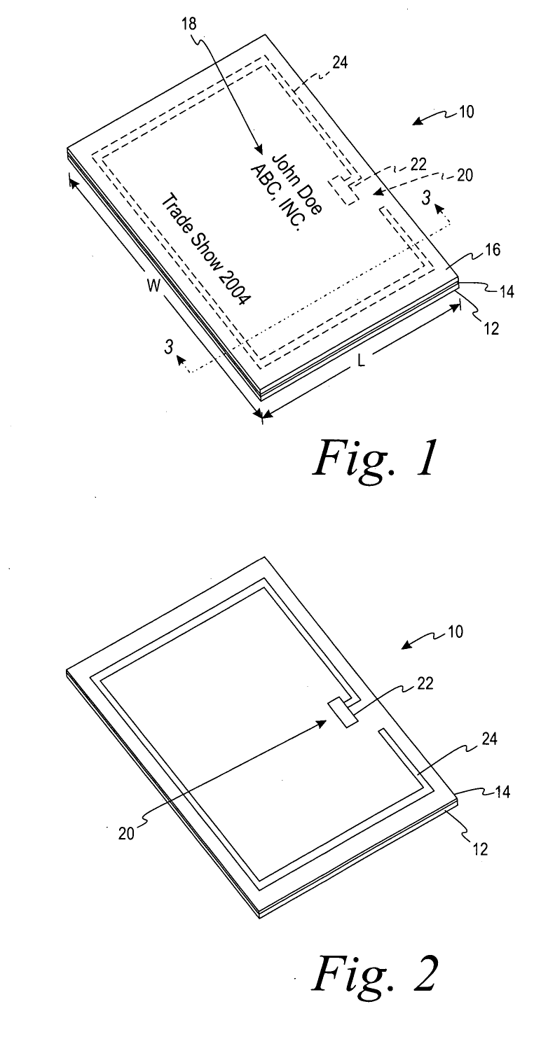

Referring now to the drawings, and initially to FIG. 1, the present invention is directed to identification badges containing a radio frequency identification (“RFID”) device that are suitable to be used at a convention, tradeshow, exhibition, and the like. One type of identification badge is shown in FIG. 1. An identification badge 10 of FIG. 1 includes a first layer 12, a second layer 14, a third layer 16, printed information 18, and an RFID device 20 (shown in broken lines). The badge 10 has a length L and a width W shown in FIG. 1. The length L shown in FIG. 1 of the badge 10 is approximately three (3) inches. The length W shown in FIG. 1 of the badge 10 is also approximately four (4) inches. It is also contemplated that in alternative embodiments the dimensions of the badge may be modified, such as a four inch by four inch badge, or other common identification badge size. It is also contemplated in an alternate embodiment of the present invention that a badge may contain a media separation feature. The media separation feature may be a punch through the badge or a dark mark on the front or back of the badge. The media separation feature allows badges to be provided in a roll form or in a z-fold arrangement, and the media separation feature is determined by a printer to be the boundary from one badge to another.

The first layer 12 of the identification badge 10 may be made from a variety of materials including paper, cardboard, cardstock, polypropylene, polyester, polyethylene, polyimide, DuPont TYVEK®, other polymeric materials, and combinations thereof. Other commercially available materials include VALERON® strength films, V-MAX® printing film, and DuPont KAPTON®. The material used for the first layer 12 will often depend on the needs of the issuer of the identification badge 10. The badge 10 will be less expensive when the first layer 12 is paper compared to a polymeric material, however, the badge 10 will often be more durable when the first layer 12 is a polymeric material compared to paper. The first layer 12 has an inner surface 12b and an outer surface 12a (FIG. 3).

The badge 10 also includes the third layer 16. Like the first layer 12, the third layer 16 may be made from a variety of materials. Materials that may be used for the third layer 16 include: paper, polypropylene, polyester, polyethylene, polyimide, DuPont TYVEK®, other polymeric materials, and combinations thereof. Other commercially available materials that may be used include VALERON® strength films, V-MAX® printing film, and DuPont KAPTON®. The material used for the third layer 16 depends on the needs of the issuer of the identification badge 10. The badge 10 will be less expensive when the third layer 16 is paper compared to a polymeric material, however, the badge 10 will often be more durable when the third layer 16 is a polymeric material compared to paper. The third layer 16 has an inner surface 16b and an outer surface 16a (FIG. 3).

As shown by the embodiment in FIG. 1, the badge 10 includes the second layer 14. The second layer 14 allows the RFID device 20 to be secured between the inner surface 12b of the first layer 12 and the inner surface 16b of the third layer 16. The second layer also secures the first layer 12 and the third layer 16. The adhesive of the second layer 14 is selected so as to secure the RFID device 20, the third layer 16, and the first layer 12 to the second layer 14. The layers are secured so that the layers of the badge 10 may not be separated without damaging the badge 10.

In an alternate embodiment of the present invention a fastener is used instead of second layer 14. The fastener would join together the inner surface of the first layer, the RFID device, and the inner surface of the third layer. The fastener could be a plurality of staples, clips, or other fasteners known in the art.

As illustrated in FIG. 1, the third layer 16 of the badge 10 also includes printed information 18. The printed information in many instances may be further broken down into indicia of a visitor, or visitor information, who will wear the badge 10, such as the visitor's name and employer, and exhibit information, such as the name and organizer of the exhibit. In many cases the exhibit information will be printed on the third layer 16 prior to the manufacture of the badge 10. The indicia of a visitor is typically printed on the third layer 16 after the manufacture of the badge 10. The visitor information of the printed information 18 may be printed onto the third layer by a variety of methods including, direct thermal printing, thermal transfer printing, laser printing, ink jet printing, dot matrix printing, or some combination thereof. In order for direct thermal printing to be used on the badge 10, the third layer 16 must be a specially treated material, typically paper, such that areas of the third layer 16 would change color from white to black when heat is applied to the material. A known printer suitable for use with the present invention is the ZEBRA® R402TM printer.

In an alternate embodiment of the present invention it is contemplated that both the indicia of a visitor and the exhibit information will be printed on the third layer 16 after the manufacture of the badge 10.

In another alternate embodiment of the present invention it is also contemplated that both the visitor information and the exhibit information will be printed on the third layer 16 before the manufacture of the badge 10.

In yet another alternate embodiment of the present invention it is contemplated that indicia of a visitor may be printed on the first layer 12.

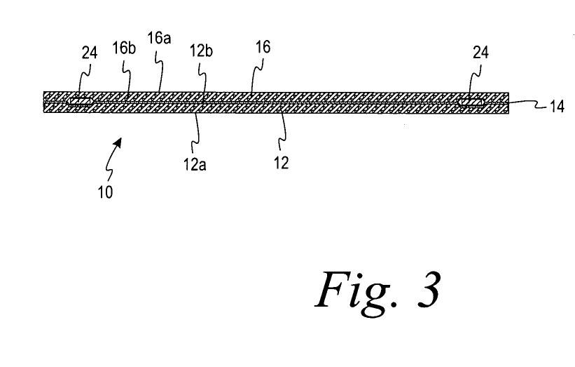

Turning next to FIG. 2, the badge 10 is shown without the third layer 16 to allow a clearer view of the RFID device 20. The RFID device 20 includes a memory 22 and an antenna 24. RFID devices are commercially available from many sources, such as TEXAS INSTRUMENTS® TAG-IT® HF transponder inlays and TI-RFID® products. The memory 22 of the RFID device 20 is capable of storing information regarding the visitor who has been issued the badge 10, such as the visitor's identification number, name, employer or organization, email address, phone number, and business address. This information stored in the memory 22 of the RFID device 20 can be transmitted from the antenna 24 to an RFID reading lead retrieval device located at an individual exhibit at the exhibition. The RFID reading device then captures this information in a form that allows the exhibitor to effectively use the information.

Referring now to FIG. 3, a cross section of the badge 10 is shown. The relation between the second layer 14 and the first and third layers 12, 16 can be noted. FIG. 3 also shows the relationship between the antenna 24 of the RFID device and the first and third layers 12, 16. The antenna 24 is located between the inner surfaces of first and third layers 12b, 16b, and the first and third layers 12, 16 envelop the antenna 24 of the RFID device. The first and third layers 12, 16 conform around the RFID device of the badge 10.

The badge 10 of the present invention is adapted to be placed within a typical trade show badge holder. It is also contemplated that in an alternate embodiment punch holes may be punched in the badge so that no trade show badge holder is required. In such an alternate embodiment, a lace is placed through the punch holes and around the neck of the badge wearer. Such an alternate embodiment could reduce the cost to the trade show organizer of issuing badges to the visitors, by eliminating the badge holder.

In another alternate embodiment of the present invention an identification badge includes a first layer, a second layer, an RFID device, a third layer, and a fourth layer. In this embodiment, the first layer and the fourth layer of the badge may be made from a variety of materials including paper, cardboard, cardstock, polypropylene, polyester, polyethylene, polyimide, DuPont TYVEK®, other polymeric materials, and combinations thereof. The second layer is an adhesive and is applied to the inner surface of the first layer. The RFID device is placed in contact with the second layer. The third layer is an adhesive and is applied to the RFID device on the side of the RFID device opposite the second layer. The fourth layer contacts the third layer. The second and third layers secure the RFID device between the first and fourth layers of the badge.

While particular embodiments and applications of the present invention have been illustrated and described, it is to be understood that the invention is not limited to the precise construction and compositions disclosed herein and that various modifications, changes, and variations may be apparent from the foregoing descriptions without departing from the spirit and scope of the invention as defined in the appended claims.

1. A trade show identification badge, comprising:
a first layer;
a second layer being an adhesive;
a third layer; and
an RFID device, the RFID being secured between the first layer and the third layer by the second layer, the second layer also securing the first layer to the third layer.

2. The identification badge of claim 1, wherein the third layer comprises direct thermal paper.

3. The identification badge of claim 1, wherein the third layer comprises paper.

4. The identification badge of claim 1, wherein the third layer comprises a polymeric material.

5. The identification badge of claim 1, wherein the first layer comprises paper.

6. The identification badge of claim 1, wherein the first layer comprises a polymeric material.

7. The identification badge of claim 1, further comprising at least one media separation feature.

8. The identification badge of claim 7, wherein the at least one media separation feature is a punch hole through the first, second, and third layers that does not contact the RFID device.

9. The identification badge of claim 7, wherein the at least one media separation feature is a perforation along an edge of the badge.

10. The identification badge of claim 7, wherein the at least one media separation feature is a dark mark on the outer surface of the first layer.

11. The identification badge of claim 1, wherein the badge has a width dimension of about 4 inches and a length dimension of about 3 inches.

12. The identification badge of claim 1, wherein the badge has a width dimension of about 4 inches and a length dimension of about 4 inches.

13. The identification badge of claim 1, wherein the RFID device comprises a memory and an antenna.

14. The identification badge of claim 13, wherein the memory contains information regarding a badge wearer.

15. The identification badge of claim 1, wherein the outer surface of the first layer contains indicia of a badge wearer.

16. The identification badge of claim 15, wherein the indicia of a badge wearer comprises the badge wearer's name.

17. The identification badge of claim 1, wherein the outer surface of the third layer contains indicia of a badge wearer.

18. The identification badge of claim 17, wherein the indicia of a badge wearer comprises the badge wearer's name.

19. The identification badge of claim 1, wherein the first layer having an inner surface and an outer surface, the second layer securing the inner surface of the first layer.

20. The identification badge of claim 19, wherein the second layer securing the inner surface of the first layer secures substantially all of the inner surface of the first layer.

21. The identification badge of claim 1, wherein the third layer having an inner surface and an outer surface, the second layer securing the inner surface of the third layer.

22. The identification badge of claim 21, wherein the second layer securing the inner surface of the third layer secures substantially all of the inner surface of the third layer.

23. A trade show identification badge, comprising:
a first layer having an inner surface and an outer surface;
an RFID device including a memory and an antenna, the RFID device contacts the inner surface of the first layer;
a second layer having an inner surface and an outer surface, the inner surface of the second layer contacts the RFID device and the inner surface of the first layer; and
at least one fastener connecting the second layer to the first layer, the at least one fastener securing the RFID device between the first layer and the second layer.

24. A method of manufacturing a trade show identification badge, the method comprising the acts of:
providing a first layer having an inner surface and an outer surface;
providing an RFID device;
providing a third layer having an inner surface and an outer surface;
applying a second layer being an adhesive to the inner surface of the first layer;
securing the RFID device to the second layer; and
securing the inner surface of the third layer to the second layer.

25. A method of manufacturing a trade show identification badge, the method comprising the acts of:
providing a first layer having an inner surface and an outer surface;
providing an RFID device;
providing a second layer having an inner surface and an outer surface;
providing at least one fastener;
placing the RFID device in contact with the inner surface of the first layer; and
securing the second layer to the first layer with the at least one fastener, such that the RFID device is secured between the inner surface of the first layer and the inner surface of the second layer.
